(19) United States
(12) Patent Application Publication
(10) Pub. No.: US 2006/0173889 A1
(43) Pub. Date: Aug. 3, 2006

(54) Method and system, in addition to computer program comprising program coding elements and computer program product for analyzing user data organized according to a database structure

(76) Inventors: Michael Haft, Zorneding (DE); Reimar Hofmann, Munchen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/526,160

(22) PCT Filed: Sep. 2, 2003
(86) PCT No.: PCT/EP03/09752

§ 371 Date: Sep. 26, 2005

(30) Foreign Application Priority Data
Sep. 2, 2002 (DE) 102 40 443.7

(51) Int. Cl. G06F 7/00; G06F 17/00

(52) U.S. Cl. 707/102

(57) ABSTRACT

The invention relates to analysis of user data organized according to a database structure, such as customer data or product data in a company.

Method and arrangement and also computer program having program code means and computer program product for analyzing user data organized according to a database structure.

The invention relates to analysis of user data organized according to a database structure, such as customer data or product data in a company.

Almost any process in a company, and any contact via the company with a customer or any logistical process within a company, starting with ordering of a product through to delivery of the finished product, is today performed or supervised and controlled with electronic support.

This involves systematically capturing and logging data, for example customer data or product data, which are the basis for economic, business and/or market-strategy analyses used to convert the data into usable economic, business and/or market-strategy findings.

Their economic, business and/or market-strategy significance means that these company data are an important asset for the companies. Accordingly, the companies make great efforts in capturing and analyzing these data.

To capture such company data, there are various, generally known systems available, such as customer relationship management (CRM) systems [1], supply chain management (SCM) systems [2] or data warehouses [3].

Following capture, the data are usually stored in databases and are stored in appropriately organized form. Normally, this involves forming data records Di=(Ai, Bi, Ci, . . . ), with the index i denoting the respective data record Di.

Each data record Di represents a particular object from a group of objects, for example a particular customer from all of a company's recorded customers or a particular product from a product line in a company.

In this case, each data record comprises a prescribable number of entries, Ai, Bi, Ci, . . . , the individual captured data items, with categories or attributes A, B, C, . . . These categories or attributes represent properties of an object group, such as age (A), income (B), product purchased (C), . . . The entries Ai, Bi, Ci, . . . for the respective categories A, B, C, . . . may be of numerical or semantic type in this case.

Such company data are analyzed using statistical methods, “data mining methods” [4], [10], [11], [12]. Many of these data mining methods are in this case based on a static framework, i.e. they are formulated in a statistical language.

One sufficiently well known and frequently used data mining method is a “decision tree” [5].

Further known data mining methods which are used are “clustering” methods [6] or association rules [9].

A drawback of many of the known analysis methods mentioned is that they can be applied only inadequately for analyzing large volumes of data. The reason for this is that this normally requires single or multiple access to the entire stock of data for analysis, which is stored in a database, for example.

With large volumes of data, this results in long access times, long processing and response times and consequently poor performance. It is also necessary to have a high level of processing power or processing capacity too.

[7] discloses ascertainment of a common probability model P(A, B, C, . . . , X) for a data structure (A, B, C, . . . ) based on a hidden variable X.

[8] discloses ascertainment of a common probability model P(A, B, C, . . . ,) for a data structure (A, B, C, . . . ) based on structure learning.

The invention is based on the object of specifying an analysis method for analyzing organized user data which (method) can also be applied for large volumes of user data and also has a high level of performance in that case.

This object is achieved by the method and the arrangement and also by the computer program having program code means and the computer program product for analyzing user data organized according to a database structure which have the features in line with the respective independent patent claim.

The method for analyzing user data organized according to a database structure involves a common statistical probability model first being ascertained for the user data organized according to the database structure. The user data organized according to the database structure are then analyzed using a statistical analysis method, with the statistical analysis method used for the analysis being applied to the common statistical probability model, not directly to the output data, as is customary.

The arrangement for analyzing user data organized according to a database structure has:

a modeling unit which can be used to ascertain a common statistical probability model for the user data organized according to the database structure, and

an analysis unit which can be used to analyze the user data organized according to the database structure using a statistical analysis method such that the statistical analysis method used for the analysis is applied to the common statistical probability model.

Seen clearly, the invention is based on a two-stage procedure.

The first assumption is prescribable user data organized according to a database structure. In this case, such database organization is to be understood to mean that the user data are based on a superordinate fixed structure, for example data records (Ai, Bi, Ci, . . . ) which are each organized in the same way and have the same entry categories A, B, C, . . . Such structures are general knowledge.

These user data for analysis which are organized according to a database structure are used to form a common, multipurpose probability model, as described in [7], [8], for example.

This model is a general, complete and accurate map of a statistic for the data structure of the organized user data (“analytical database map”). In addition, it is a highly compressed form of knowledge about the user data.

The general map can then subsequently be used as a basis for the analysis by the statistical methods. These then no longer access the entire stock of user data or the individual user data items, but rather use the statistical map created, i.e. the common probability model, for the analysis.

This allows a reduction in the access, processing and response times for the analysis and hence an increase in the performance.

The inventive computer program having program code means is set up to perform all of the steps in line with the inventive analysis method when the program is executed on a computer.

The computer program product having program code means stored on a machine-readable medium is set up to perform all of the steps in line with the inventive analysis method when the program is executed on a computer.

The arrangement and also the computer program having program code means, set up to perform all of the steps in line with the inventive analysis method when the program is executed on a computer, and also the computer program product having program code means stored on a machine-readable medium, which are set up to perform all of the steps in line with the inventive analysis method when the program is executed on a computer, are particularly suitable for carrying out the inventive analysis method or one of its developments explained below.

Preferred developments of the invention can be found in the dependent claims.

The developments described below relate both to the methods and to the arrangement.

The invention and the developments described below can be implemented either using software or using hardware, for example using a specific electric circuit.

In addition, the invention or a development described below can be implemented by a computer-readable storage medium which stores the computer program with program code means which implements the invention or development.

It is also possible for the invention or any development described below to be implemented by a computer program product which has a storage medium storing the computer program with program code means which implements the invention or development.

In one development, user data organized into user data records are used, for example user data records from a database. In this case, each user data record represents a particular object from a group of objects. The user data associated with the respective user data record describe properties of the respective object in this case.

To ascertain the common statistical probability model, it is possible to use statistical methods based on a hidden variable [7] or methods based on structure learning [8]. A combination of both methods is also possible.

It is also expedient that the statistical analysis method is applied to the common statistical probability model such that a common probability is used as input variable for the statistical analysis method. The common probability is obtained directly from the common probability model. This makes it possible to avoid unnecessary intermediate steps which cost processing time and extend response times.

The statistical analysis method used may be a method based on a data mining method [4], [10], [11], [12], for example a clustering method [5] or a decision tree [6] or association rules [9].

During the analysis using the statistical analysis method, it is possible to ascertain dependencies between the user data and/or the significances thereof based on a statistical test. This can be done interactively and very efficiently on account of the highly compressed form of the user data, i.e. of the common probability model.

It also makes sense for the common statistical probability model to be ascertained and for the common statistical probability model to be analyzed by the statistical analysis method at different times and locations.

By way of example, the analytical database map, i.e. the common probability model, can thus be formed afresh at prescribable intervals of time, such as daily or weekly. It may be formed at night or at the weekend. The complete analytical database map is then available when needed in order to speed up analyses considerably.

The user data may be obtained from various data sources. It is easiest to obtain the user data from a database in which the user data are stored and from which they are read.

On account of the performance which it can achieve when analyzing data, the invention is particularly suitable when large volumes of data need to be processed or analyzed, as in the area of customer relationship management (CRM) [1] or supply chain management [2] or a data warehouse (DW) [3].

In the CMR field, one development may be used, by way of example, to analyze customer data. In this case, the object is a customer who is described by at least two of the following properties: age, income, product purchased, date of purchase, frequency of purchases. This allows marketing departments to solve eminently important problems, such as a customer behavior in particular customer groups. On that basis, target groups can be determined more specifically when acquiring customers, customer groups can be selected more appropriately for particular products and marketing campaigns, and customers can generally be served with more foresight.

An exemplary embodiment of the invention is shown in figures and is explained below.

### In the figures

FIG. 1 shows a sketch schematically showing the way in which an analysis system works for analyzing customer data based on an exemplary embodiment;

FIGS. 2a to g show sketches showing the analysis results from an analysis system for analyzing customer data based on an exemplary embodiment. 456

### EXEMPLARY EMBODIMENT

Analysis System for Analyzing a Customer Behavior in a Bank Based on a Customer Relationship Management System.

The subject matter of the exemplary embodiment is an analysis system for analyzing customer data in a bank.

It should first of all be pointed out that the analysis system described below can be used not only in banks but also in any companies to analyze appropriate company data, such as in warehouses or manufacturing companies.

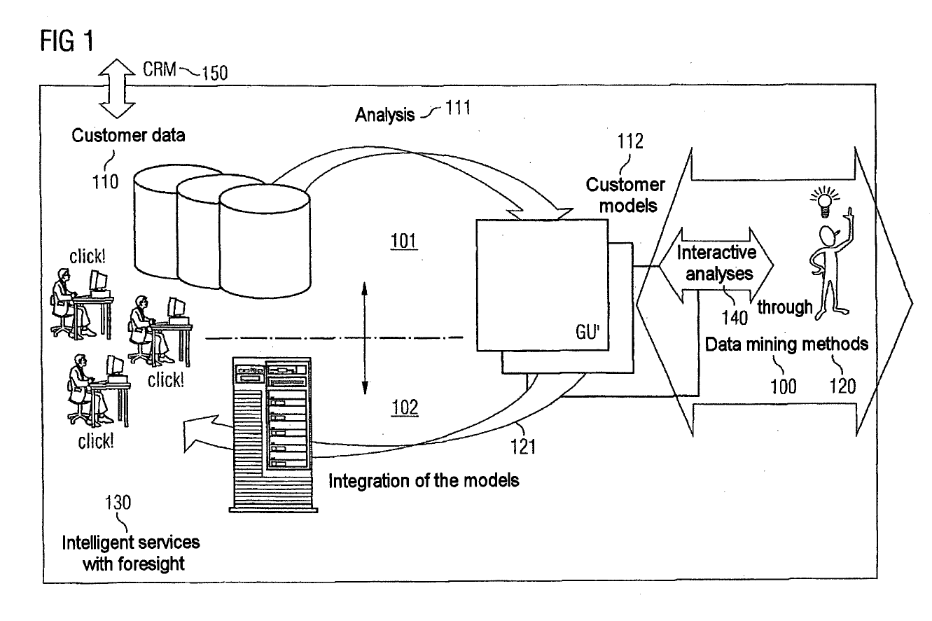

The Way in which the Analysis System works (FIG. 1)

FIG. 1 schematically shows the way 100 in which the analysis system for analyzing the bank customer data 110 works.

The way 100 in which it works is divided into acquisition of knowledge 101 and conversion of the knowledge into intelligent service for the bank customers 102.

Large and hence difficult-to-handle volumes of customer data 110 are first of all condensed 111 to produce a statistical model 112, a common probability model, of the customer behavior.

The common probability model 112 used is one based on a hidden variable. Principles relating to this are described in [7].

It should be noted that it is also possible to use other types of common probability models, such as those based on structure learning [8].

The common probability model 112 can be used to explore properties of the customers and particularly their behavior over time very much more efficiently and flexibly than when using the output data.

To this end, statistical methods 120, generally data mining methods and in this case a decision tree, are used which is or are based on the statistical model.

It should be noted that it is also possible to use other data mining methods, such as clustering methods or association rules.

Principles relating to data mining methods are described in [4], [10], [11], [12], principles relating to a decision tree are described in [6] and principles relating to clustering methods are described in [5].

Coupling is made possible by virtue of the data mining methods or the decision tree 120 being based on a statistical framework and hence using the same statistical terms or the same statistical language as the common probability model 112.

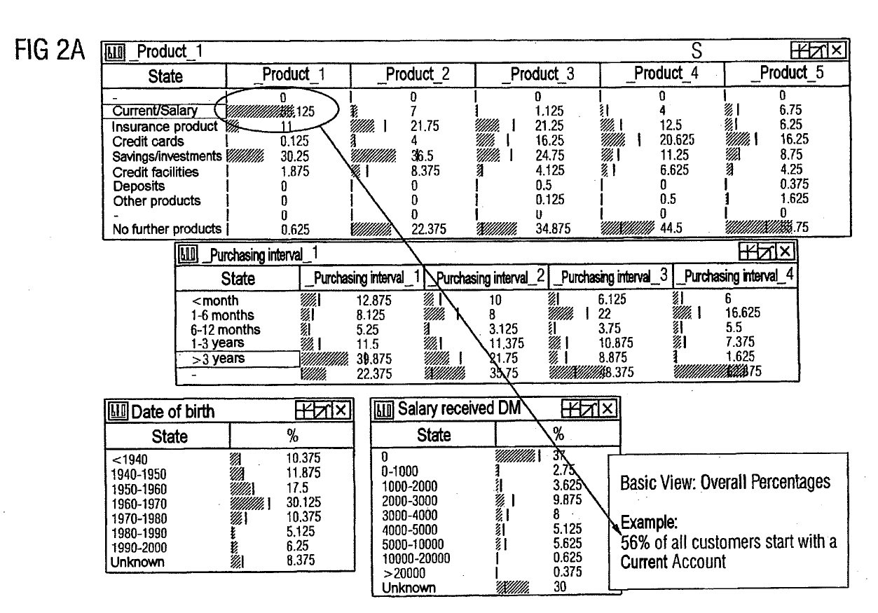

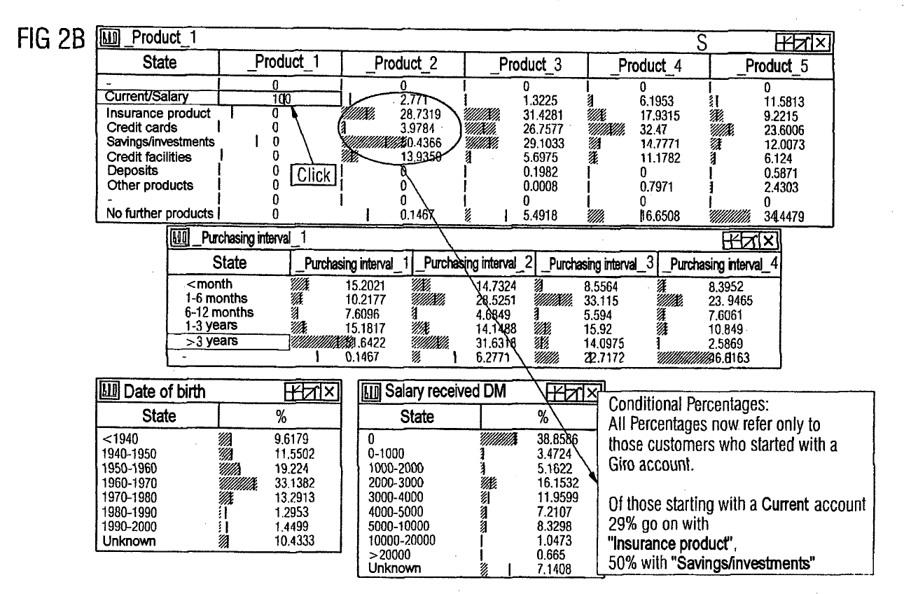

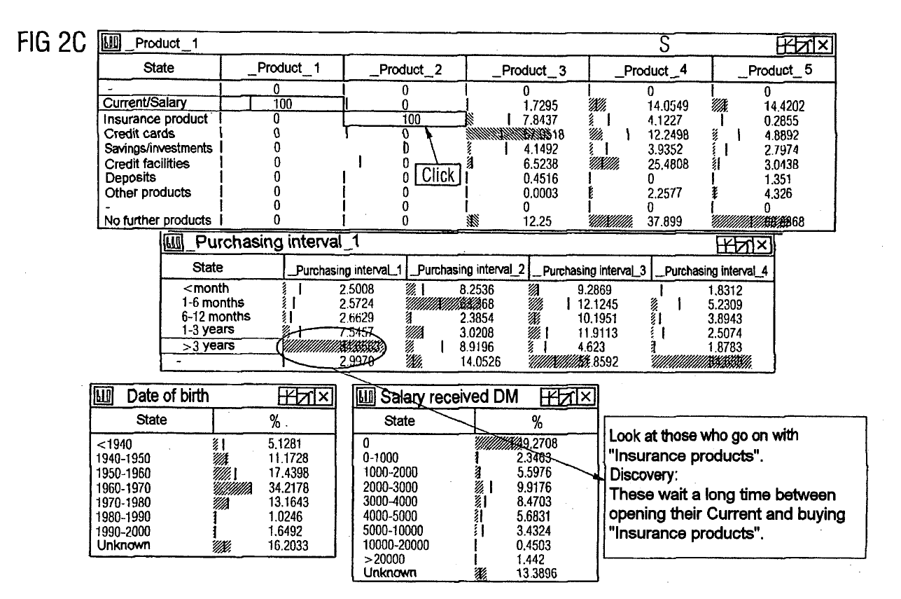

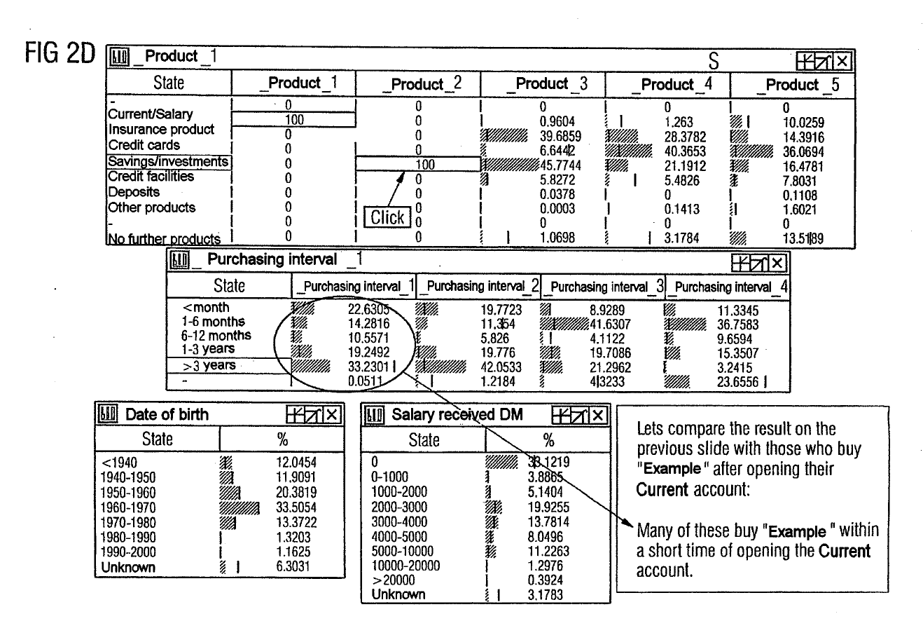

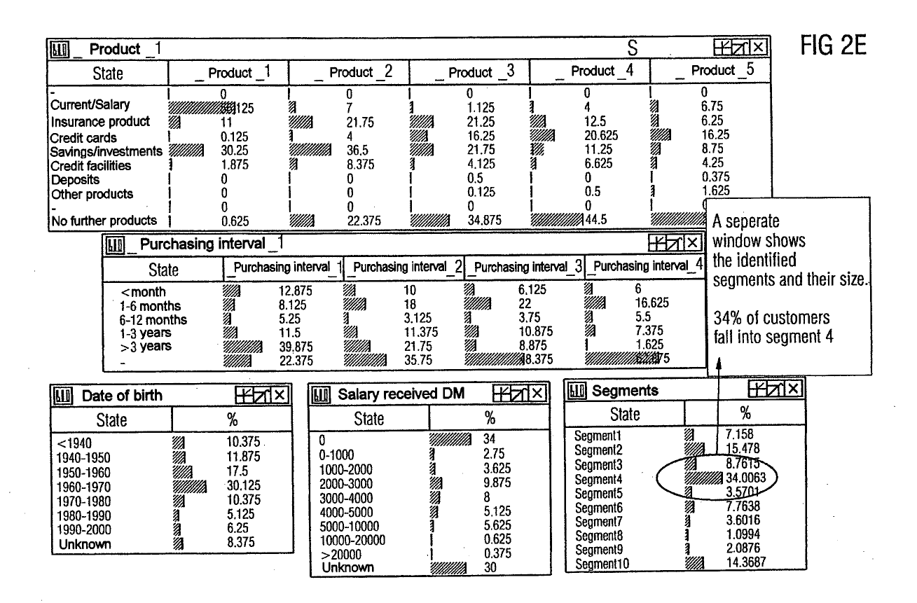

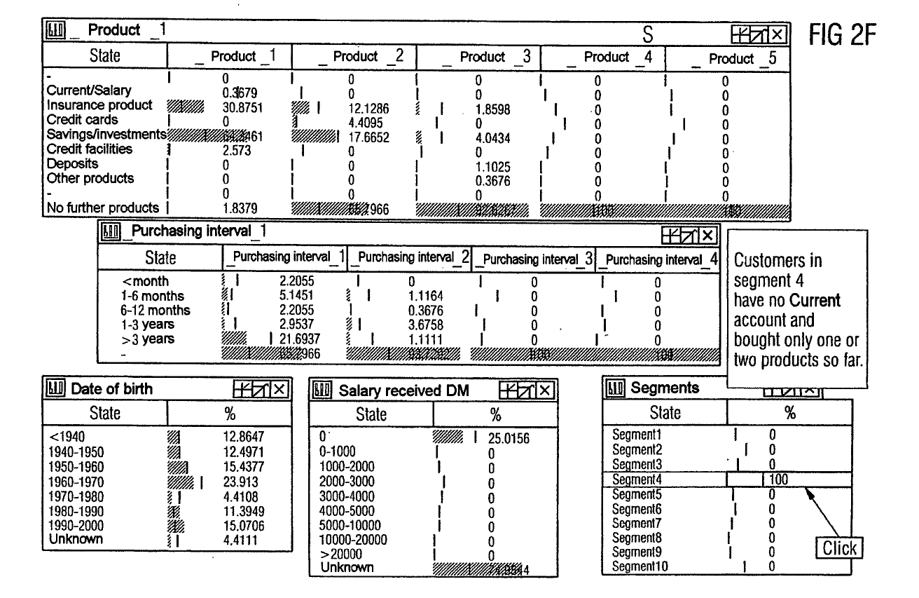

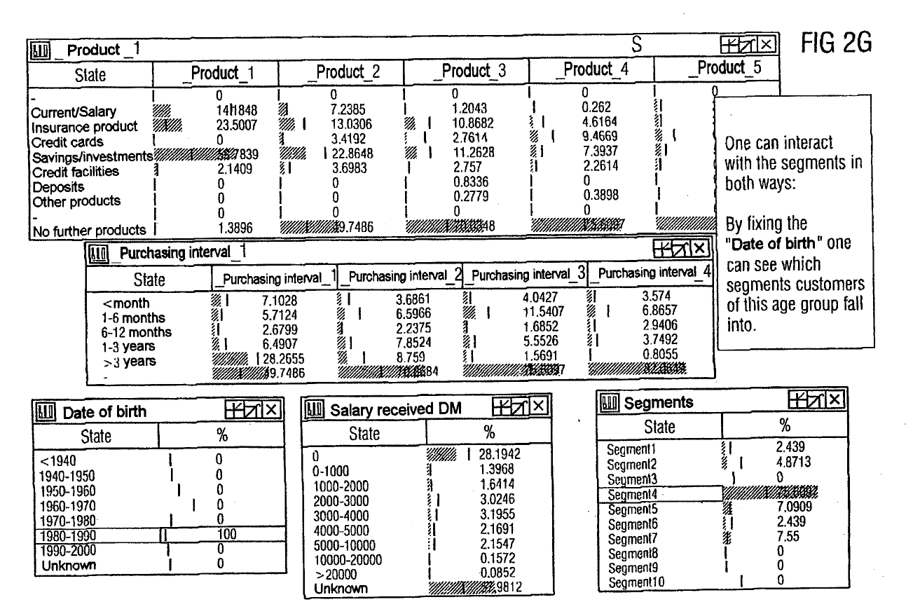

Important questions (cf. FIG. 2) can be answered 140 interactively using the decision tree 120 and resorting to the common probability model 112.

It is thus possible to view the customers not only quantitatively (how many customers?) but also qualitatively (what sort of customers?), e.g.:

How many and what quality of customers come through which partnerships or campaigns? How efficient are my advertising measures?

What classes of customer with what preferences and needs are there? How and when can these needs be met best?

Results from the questions can then be converted 121 into intelligent service for the customers 130.

Customer Data (FIG. 1, 110)

The customer data 110 in the analysis system are collected in the course of customer relationship management (CRM) 150.

Principles relating to CRM are described in [1].

The CRM 150 involves large volumes of data 110 about the bank customers being captured and stored from all of the bank's sales channels, such as direct contact, web, call centre.

The following are respectively captured and stored for the customers (attributes A, B, C, . . . ):

the bank's products A purchased in the respective chronological order (A1, A2, A3, . . . ),

a purchasing interval of time B between the purchase times for the bank's products purchased (B1-2, B2-3, B3-4, . . . ),

a date of birth (C),

an income (D),

an address (E),

the last visit to the bank (F),

the last account movement (G).

These are stored in a database in the form of customer-specific data records Di(A1, A2, . . . , B1-2, B2-3, . . . , C, D, . . . ), where the index i identifies the respective bank customer i.

Common Probability Model (FIG. 1, 112)

The knowledge about the bank customers, which is hidden in these data 110, is then condensed to produce a model, the common probability model 112.

The common probability model 112 used is one based on a hidden variable X. Principles relating to this are described in [7].

The common probability model 112 based on the hidden variable X is written as P(A, B, C, . . . , X) for all attributes (A, B, C, . . . ).

Such a statistical map of data is a highly compressed form of knowledge about customers and can be used to explore 120, 140 dependencies efficiently and interactively.

Using the common probability model 112 created here, it is now possible to pick off the knowledge about the customers quickly and efficiently, and in particular it is possible to study modes of behavior in the customers easily and flexibly, to analyze typical behavior patterns and development cycles in customers efficiently and intuitively, and to determine and recognize 120, 140 typical customer segments and their preferences with certainty and unambiguously.

In addition, the common probability model 112 provides not only the analysis function described but also quickly retrievable prognoses about a customer's further behavior which can be expected and current needs. The prognoses may also be used to serve customers with foresight and in targeted fashion and to provide 130 proactive, personal offers.

Adding a Decision Tree to the Common Probability Model (FIG. 1, 120)

In a further use of the common probability model 112, the decision tree [6] is placed 120 onto the statistical model 112, the common probability model 112.

It is thus possible to ascertain arbitrary edge distributions, such as those for a first split in the decision tree, namely P(A, X), P(B, X), P(C, X), . . . , and also for all further splits in the decision tree.

Furthermore, it is also possible to ascertain all of the basic probability distributions or basic probabilities P(A), P(B), . . . and arbitrary conditional probabilities or probability distributions P(B|A), P(C|A), P(C|B), . . .

The common distribution P(A, B, C, . . . , X) based on the hidden (or latent) variable X first of all produces the common distribution P(A, B, C, . . . ) over all attributes of the customers by summing using the hidden variable X.

In this case, structure learning provides a common distribution P(A, B, C, . . . ) directly.

From the common distribution, it is then possible to derive arbitrary one-dimensional edge distributions (marginals) P(A), P(B), . . . , low-dimensional distributions P(A,B), P(B,C), . . . and arbitrary conditional probabilities (one-dimensional or multi-dimensional) P(B|A), P(C|A), P(A,C|B), . . .

This is done in the course of an inference process, as described in [13].

In this case, in accordance with [13], the structure of the models, for example those with a prescribed hidden variable or those which have been produced by structure learning, or a combination of the above is used to calculate required sums relating to the common distribution efficiently.

Decision trees are usually constructed on the basis of a known CHAID or a known CART method.

Generally, constructing a decision tree with a target variable (or dependent variable) A for the “first split” first of all requires all of the paired distributions P(A,B), P(B,C), P(A,D), . . .

One variable from the set of variables B, C, D, . . . , for the first split is then selected in almost all known methods based on a statistical criterion (a statistical test and significance criteria) based on the paired distributions P(A,B), P(B,C), P(A,D), . . . and a known number of data items.

If the variable D with the two values d1 and d2 has been chosen for the first split, for example, then conditional, paired distributions in the form P(A,B|d1), P(A,B|d2), P(A,C|d1), P(A,C|d2), . . . are required for the second split.

The required probabilities or distributions for constructing the decision tree (or as bases for the required statistical tests) can (as usual) be ascertained from the data or else from a probability model (inference process) which is as accurate as possible (described above).

Interactive Analyses (FIG. 1, 140, FIGS. 2a to 2g)

FIGS. 2a to 2g show, as examples, some of the possible interactive analyses 140 which can be performed using the decision tree 120 and resorting to the common probability model 112.

FIG. 2a shows probability distributions P(A1), P(A2), P(A3), P(A4), P(A5), P(B1-2), P(B2-3), P(B3-4) and P(C) and P(D). Particular identification is given to P(A1=“Current/Salary account)=56.125%.

FIG. 2b now shows conditional probability distributions under the condition A1=“Current/salary account”, namely P(A2|A1=“Current/salary account”), P(A3|A1=“Current/salary account”), P(A4|A1=“Current/salary account”), P(A5|A1=“Current/salary account”), P(B1-2|A1=“Current/salary account”), P(B2-3|A1=“Current/salary account”), P(B3-4|A1=“Current/salary account”) and P(C1|A1=“Current/salary account”) and P(D|A1=“Current/salary account”). Particular identification is given to P(A2=“Insurance product|A1=“Current/salary account”)=29% and P(A2=“Savings/Investments”|A1=“Current/salary account”)=50%.

FIG. 2c now shows conditional probability distributions under the conditions A1=“Current/salary account” and A2=“Insurance product”, namely P(A3|A1=“Current/salary account”, A2=“Insurance product”, P(A4|A1=“Current/salary account”, A2=“Insurance product”, P(A5|A1=”Current/salary account”, A2=“Insurance product”), . . . Particular identification is given in this case to P(B1-2=“Purchase interval between first and second products greater than 3 years|A1 =“Current/salary account”, A2=“Insurance product)=85%.

FIG. 2d shows further conditional probability distributions under the conditions A1=“Current/salary account”and A2=“Savings/Investments”, namely P(A3|A1=“Current/salary account”, A2=“Savings/Investments”), P(A4|A1=“Current/salary account”, A2=”Savings/Investments”), P(A5|A1=“Current/salary account”, A2=“Savings/Investments”) . . . Particular identification is given in this case to the probability distributions P(B1-2|A1=“Current/salary account”, A2=“Savings/Investments”).

FIG. 2e shows the probability distributions P(A1), P(A2), P(A3), P(A4), P(A5), P(B1-2), P(B2-3), P(B3-4) and P(C) and P(D). Particular identification is given to P(A1=“Current/salary account)=56.125%. In addition, FIG. 2e shows the probability distribution for the hidden variable X, in this case referred to as segments, namely P(segments). Particular identification is given to P(segments=4)=34%, which shows that 34% of all bank customers recorded fall into segment 4.

FIGS. 2f and 2g in turn show the conditional probability distributions, once under the condition segments=4 (FIG. 2f) and the other time under the condition C=date of birth between 980 and 1990 (FIG. 2g).

The following publications are cited as part of this document:
[1] Customer Relationship Management System, available on 08.31.2002 at: http://www.crm-expo.com/.
[2] Supply Chain Management System, available on Jun. 31, 2002 at:

http://www.sap-ag.de/germany/solutions/scm/.
[3] Data Warehouse, available on Aug. 31, 2002 at:

http://www.data-warehouse-systeme.de/.

[4] Heckermann, D., “Bayesian Networks for Data Mining”, Data Mining and Knowledge Discovery, pages 79 to 119, 1997.
[5] Kass, G., “An exploratory technique for investigating large quantities of categorical data”, Applied Statistics, 29:2, pages 119 to 117, 1980.
[6] Bezdek, J. C., Pal, S. K., “Fuzzy Models for Pattern Recognition”, IEEE Press, 1992.
[7] Everitt, B. S., “An Introduction to Latent Variable Models”, London, Chapman and Hall, 1984.
[8] Reimar Hofmann, “Lernen der Struktur nichtlinearer Abhängigkeiten mit graphischen Modellen”, [Learning the structure of nonlinear dependencies using graphical models], Thesis at Technische Universität München, published at: dissertation.de, ISBN: 3-89825-131-4.
[9] Ashoka Savasere, Edward Omiecinski, Shamkant B. Navathe, “An Efficient Algorithm for Mining Association Rules in Large Databases”, The VLDB Journal, pages 432 to 444”, 1995.
[10] Usama M. Fayyad, Gregory Piatetsky-Shapiro, Padhraic Smyth and Ramasamy Uthurusamy, “Advances in Knowledge Discovery and Data Mining”, American Association for Artificial Intelligence, Calif., 1996.
[11] Ian H. Witten, Eibe Frank, Morgan Kaufmann, Data Mining, 2000.
[12] T. Hastie, R. Tibshirani, J. H. Friedman, “The Elements of Statistical Learning: Data Mining, Inference, and Prediction”, Springer Series in Statistics.
[13] Jensen, V. J., “An Introduction to Bayesian Networks”, UCL Press, London, 1996.

1. A method for analyzing user data organized according to a database structure,
in which a common statistical probability model is ascertained for the user data organized according to the database structure,
in which the user data organized according to the database structure are analyzed using a statistical analysis method, with the statistical analysis method used for the analysis being applied to the common statistical probability model.

2. The method as claimed in claim 1, in which the user data organized according to the database structure are organized into user data records, which user data records each represent an object, with the user data in a user data record describing properties of the respective object.

3. The method as claimed in claim 1 or 2, in which the common statistical probability model is ascertained on the basis of a hidden variable.

4. The method as claimed in one of claims 1 to 3, in which the common statistical probability model is ascertained on the basis of structure learning.

5. The method as claimed in one of the preceding claims,
in which the statistical analysis method is applied to the common statistical probability model such that a common probability in the common probability model is used as input variable for the statistical analysis method.

6. The method as claimed in one of the preceding claims,
in which the statistical analysis method used is a method based on a data mining method.

7. The method as claimed in claim 6, in which the statistical analysis method used is a clustering method.

8. The method as claimed in claim 6,
in which the statistical analysis method used is a method known by the name “association rules”.

9. The method as claimed in claim 6, in which the statistical analysis method used is a decision tree.

10. The method as claimed in one of the preceding claims,
in which the analysis using the statistical analysis method involves dependencies between the user data being ascertained and/or the significances thereof being ascertained on the basis of a statistical test.

11. The method as claimed in one of the preceding claims,
in which the common statistical probability model is ascertained and the common statistical probability model is analyzed by the statistical analysis method at different times and locations.

12. The method as claimed in one of the preceding claims,
in which the user data are stored in a database.

13. The method as claimed in one of claims 2 to 12,
in which the object is a customer who is described by at least two of the following properties: age, income, product purchased, date of purchase, frequency of purchases.

14. The method as claimed in one of the preceding claims,
used in the data warehouse, with the user data describing the data warehouse.

15. The method as claimed in one of claims 1 to 13, used in customer relationship management or supply chain management, with the user data being customer data or product data.

16. An arrangement for analyzing user data organized according to a database structure,
having a modeling unit which can be used to ascertain a common statistical probability model for the user data organized according to the database structure,
having an analysis unit which can be used to analyze the user data organized according to the database structure using a statistical analysis method such that the statistical analysis method used for the analysis is applied to the common statistical probability model.

17. A computer program product which comprises a computer-readable storage medium storing a program which, after it has been loaded into a memory in a computer, allows the computer to perform the following steps to analyze user data organized according to a database structure:
a common statistical probability model is ascertained for the user data organized according to the database structure,
the user data organized according to the database structure are analyzed using a statistical analysis method, with the statistical analysis method used for the analysis being applied to the common statistical probability model.

18. A computer-readable storage medium storing a program which, when it has been loaded into a memory in a computer, allows the computer to perform the following steps to analyze user data organized according to a database structure:
a common statistical probability model is ascertained for the user data organized according to the database structure,
the user data organized according to the database structure are analyzed using a statistical analysis method, with the statistical analysis method used for the analysis being applied to the common statistical probability model.

19. A computer program having program code means for performing all of the steps as claimed in claim 1 when the program is executed on a computer.

20. The computer program having program code means as claimed in claim 18 which are stored on a computer-readable data storage medium.

21. A computer program product having program code means stored on a machine-readable medium for performing all of the steps as claimed in claim 1 when the program is executed on a computer.
